(19) United States
(12) Patent Application Publication
(10) Pub. No.: US 2001/0040675 A1
(43) Pub. Date: Nov. 15, 2001

(54) Method for forming a micromechanical device

(76) Inventors: Randall J. True, San Francisco, CA (US); Andrew G. Huibers, Mountain View, CA (US)

Correspondence Address: Gregory R. Muir, REFLECTIVITY, INC, 3910 Freedom Circle, Suite 103, Santa Clara, GA, 95116, US

(21) Appl. No.: 09/767,632

(22) Filed: Jan. 22, 2001

Related U.S. Application Data
(60) Provisional application No. 60/178,902, filed on Jan. 28, 2000.

(51) Int. Cl. G03B 27/32

(52) U.S. Cl. 355/77

(57) ABSTRACT

A method is disclosed for forming a micromechanical device. The method includes providing a sacrificial layer on a substrate, providing a first structural layer on the sacrificial layer and removing a portion of the first structural layer in an area intended for a hinge. Then, a second structural layer is provided over the first layer and in the removed area for the hinge. The second layer is preferably deposited directly on the sacrificial layer in this area. Last, a metal layer is deposited and the various layers are patterned to define a micromechanical device having one portion (e.g. a mirror plate) more stiff than another portion (e.g. hinge). Because a portion of the reinforcing layer is removed, there is no overetching into the hinge material. Also, because the metal layer is provided last, materials can be provided at higher temperatures, and the method can be performed in accordance with CMOS foundry rules and thus can be performed in a CMOS foundry.

### BACKGROUND

The present invention claims priority from U.S. provisional application No. 60/178,902 to True et al. and U.S. patent application Ser. No. 09/617,149 to Huibers et al., the subject matter of each being incorporated herein by reference.

### FIELD OF THE INVENTION

### Related Art

The components of a micromirror element usually include at least one hinge and the mirror plate. The hinge is the region of the micromirror that undergoes deformation, allowing the entire mirror, including the mirror plate (and optional stop) to tilt. The mirror plate occupies most of the area of each micromirror pixel and is the primary reflecting region. It is desirable to simultaneously have a pliant hinge and stiff mirror plate. A pliant hinge allows for low actuation forces (usually voltages). On the other hand, the mirror plate is preferably made rigid to provide a planar surface for light modulation.

One way of achieving a pliant hinge and rigid mirror plate is to use two layers of different thicknesses. A specific example of a structure using this approach is described in U.S. Pat. No. 4,662,746, henceforth referred to as the “protected hinge” process. The fundamental characteristic of the protected hinge process is the realization of a hinge that is formed only in the first layer. The region that is to become the hinge is protected by an etch stop material. When the second layer is etched to define the mirror plate, the etch stop protects the first layer in the hinge region. The first layer is etched along with the second layer everywhere except for the areas protected by the etch stop (the hinge region).

### SUMMARY OF THE INVENTION

The present invention is a process in which the hinge of a micromirror device is formed after a stiffening or reinforcing layer is formed. The reinforcing layer is removed at least in the area of the hinge, after which the hinge material is deposited. This invention provides several advantages over the prior art. One advantage is that it allows over-etching of the reinforcing layer into the sacrificial layer, rather than into the hinge material. Also, the method of the invention allows the metal layer to be the last layer deposited to form the structure. The metal layer provides both optical reflectivity and electrical conductivity to the mirror structure. Depositing the metal layer last also allows high temperature materials to be used as structural layers to form the mirror and/or the hinge. The use of many high temperature ceramic materials for this purpose is desirable because of their superior mechanical properties. Being completely elastic, materials such as silicon nitride do not undergo plastic deformation after repeated cycling, a phenomena known as creep. Creep is one of the paramount technical challenge in realizing a micromirror SLM device.

In the present invention, the high temperature materials are deposited prior to depositing the metal as mentioned above, and, separately from metal deposited to form traces for the circuitry. With a (prior art) monolithic process utilizing CMOS circuitry, high temperature materials are completely forbidden because of the temperature limitation (about 400° C.) imposed by the aluminum interconnects that are deposited at the end of the CMOS processing. In the two-substrate approach of U.S. Pat. No. 5,835,256, and the present invention, however, high temperature processing can be utilized because the processing of the CMOS circuitry and micromirrors is physically separated.

In addition, depositing the metal layer last facilitates fabrication of the micromirrors in a silicon device (e.g. CMOS) fabrication facility. In CMOS, high temperature films such as thermally grown silicon oxide and poly-silicon are used in making the transistors while the metal layers are used for the interconnects of transistors and are therefore deposited near the end of the processing. Contamination of the equipment use in forming the initial layers in a CMOS process with metal is strictly forbidden in a CMOS foundry. The process that is the subject of this invention thus preserves the ordering of CMOS steps—high temperature steps followed by metalization—even though the product is ultimately a micromechanical device rather than an integrated circuit. Thus, the invention is also directed to forming a micromechanical device, e.g. micromirrors, in a CMOS foundry and following CMOS foundry processing rules.

In the present invention, the mirror hinge is preferably formed only in the second of the two layers, which is composed of a laminate of the second hinge material followed by the conducting, reflecting layer. The structure is made by depositing the reinforcing layer first, then removing it in the hinge region. Next the hinge material is deposited followed by the metallic layer. In a preferred embodiment, there is no patterning between the hinge and reinforcing layers. The pattern defines the entire mirror structure and the etch in one embodiment, proceeds through the metallic, hinge and reinforcing layers. The hinge is protected in the etch because it is part of the entire mirror pattern.

In addition to enabling the construction of the above structure, the process to form the hinge in the second of two layers is advantageous because it reduces the number of processing steps requires to make a basic two layer structure. Prior art processes which create a hinge in the 1^{st} layer need an etch stop, and the use of the etch stops add two steps, to deposit, and to finally remove the etch stop.

### BRIEF DESCRIPTION OF THE DRAWINGS

FIGS. 1A to 1D illustrate one method for forming conventional square mirrors;

FIG. 2 is a top view of a conventional mirror showing line 1-1 for taking the cross section for FIGS. 1A to 1D;

FIGS. 3A to 3D illustrate the same method as in FIGS. 1A to 1D but taken along a different cross section;

FIG. 4 is a top view of a mirror showing line 3-3 for taking the cross section for FIGS. 3A to 3D;

FIGS. 5A to 5D are illustrations of flexure hinges formed by the method of the present invention;

FIG. 6 is an illustration of the I/O pads and Si backplane for the mirror array of the present invention;

FIG. 7 is a flow chart of steps in one embodiment of the invention; and

FIGS. 8A and 8B are views of a portion of the assembled device of the present invention.

### DETAILED DESCRIPTION

### Mirror Fabrication

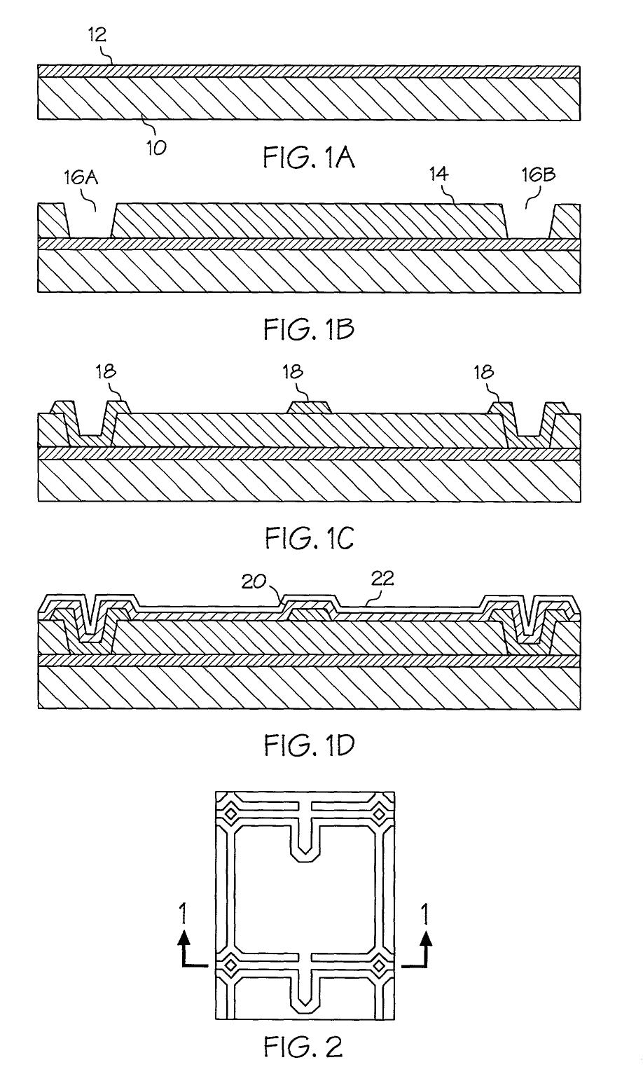

Processes for microfabricating a movable micromirror and mirror array are disclosed in U.S. Pat. Nos. 5,835,256 and 6,046,840 both to Huibers, the subject matter of each being incorporated herein by reference. A similar process for forming movable elements (e.g. mirrors) on a substrate (e.g. a light transmissive substrate) is illustrated in FIGS. 1 to 4. By “light transmissive”, it is meant that the material will be transmissive to light at least in operation of the device (The material could temporarily have a light blocking layer on it to improve the ability to handle the substrate during manufacture, or a partial light blocking layer for decreasing light scatter during use. Regardless, a portion of the substrate, for visible light applications, is preferably transmissive to visible light during use so that light can pass into the device, be reflected by the mirrors, and pass back out of the device). As can be seen in FIG. 1A, a light transmissive substrate 10 (at least prior to adding further layers thereon) such as glass, quartz, Pyrex™, sapphire, (or even silicon if infrared light is used) etc. is provided. The cross section of FIGS. 1A-D is taken along line 1-1 of FIG. 2. Because this cross section is taken along the hinge of the movable element, an optional block layer 12 can be provided to block light (incident through the light transmissive substrate during use) from reflecting off of the hinge and potentially causing diffraction and lowering the contrast ratio.

As can be seen in FIG. 1B, a sacrificial layer 14, such as amorphous silicon, is deposited. The thickness of the sacrificial layer can be wide ranging depending upon the movable element/mirror size and desired tilt angle, though a thickness of from 500 Å to 50,000 Å, preferably around 5000 Å is preferred. Alternatively the sacrificial layer could be a polymer or polyimide (or even polysilicon, silicon nitride, silicon dioxide, etc. depending upon the materials selected to be resistant to the etchant, and the etchant selected). A lithography step followed by a sacrificial layer etch forms holes 16a,b in the sacrificial silicon, which can be any suitable size, though preferably having a diameter of from 0.1 to 1.5 um, more preferably around 0.7 +/−0.25 um. The etching is performed down to the glass/quartz substrate or down to the block layer if present. Preferably if the glass/quartz layer is etched, it is in an amount less than 2000 Å.

At this point, as can be seen in FIG. 1C, a first layer 18 is deposited by chemical vapor deposition. Preferably the material is silicon nitride or silicon oxide deposited by LPCVD or PECVD, however polysilicon, silicon carbide or an organic compound could be deposited at this point (of course the sacrificial layer and etchant should be adapted to the material used). The thickness of this first layer can vary depending upon the movable element size and desired amount of stiffness of the element, however in one embodiment the layer has a thickness of from 100 to 3200 Å, more preferably around 1100 Å. The first layer undergoes lithography and etching so as to form gaps between adjacent movable elements on the order of from 0.1 to 25 um, preferably around 1 to 2 um.

A second layer 20 (the “hinge” layer) is deposited as can be seen in FIG. 1D. By “hinge layer” it is meant the layer that defines that portion of the device which flexes to allow movement of the device. The hinge layer can be disposed only for defining the hinge, or for defining the hinge and other areas such as the mirror. In any case, the reinforcing material is removed prior to depositing the hinge material. The material for the second (hinge) layer can be the same (e.g. silicon nitride) as the first layer or different (silicon oxide, silicon carbide, polysilicon, etc.) and can be deposited by chemical vapor deposition as for the first layer. The thickness of the second/hinge layer can be greater or less than the first, depending upon the stiffness of the movable element, the flexibility of the hinge desired, the material used, etc. In one embodiment the second layer has a thickness of from 50 Å to 2100 Å, and preferably around 500 Å. In another embodiment, the first layer is deposited by PECVD and the second layer by LPCVD.

As also seen in FIG. 1D, a reflective and conductive layer 22 is deposited. The reflective/conductive material can be gold, aluminum or other metal, or an alloy of more than one metal though it is preferably aluminum deposited by PVD. The thickness of the metal layer can be from 50 to 2000 Å, preferably around 500 Å. It is also possible to deposit separate reflective and conductive layers. An optional metal passivation layer (not shown) can be added, e.g. a 10 to 1100 Å silicon oxide layer deposited by PECVD. Then, photoresist patterning on the metal layer is followed by etching through the metal layer with a suitable metal etchant. In the case of an aluminum layer, a chlorine (or bromine) chemistry can be used (e.g. a plasma/RIE etch with Cl₂ and/or BCl₃ (or Cl2, CCl4, Br2, CBr₄, etc.) with an optional preferably inert diluent such as Ar and/or He).

In the embodiment illustrated in FIGS. 1A to 1D, both the first and second layers are deposited in the area defining the movable (mirror) element, whereas the second layer, in the absence of the first layer, is deposited in the area of the hinge. It is also possible to use more than two layers to produce a laminate movable element, which can be desirable particularly when the size of the movable element is increased such as for switching light beams in an optical switch. A plurality of layers could be provided in place of single layer 18 in FIG. 1C, and a plurality of layers could be provided in place of layer 20 and in place of layer 22. Or, layers 20 and 22 could be a single layer, e.g. a pure metal layer or a metal alloy layer or a layer that is a mixture of e.g. a dielectric or semiconductor and a metal. Some materials for such layer or layers that could comprise alloys of metals and dielectrics or compounds of metals and nitrogen, oxygen or carbon (particularly the transition metals) are disclosed in U.S provisional patent application No. 60/228,007, the subject matter of which is incorporated herein by reference.

Whatever the specific combination, it is desirable that the reinforcing layer(s) is provided and patterned (at least in the hinge area) prior to depositing and patterning the hinge material and metal. In one embodiment, the reinforcing layer is removed in the area of the hinge, followed by depositing the hinge layer and patterning both reinforcing and hinge layer together. This joint patterning of the reinforcing layer and hinge layer can be done with the same etchant (e.g. if the two layers are of the same material) or consecutively with different etchants. The reinforcing and hinge layers can be etched with a chlorine chemistry or a fluorine (or other halide) chemistry (e.g. a plasma/RIE etch with F₂, CF₄, CHF₃, C₃F₈, CH₂F₂, C₂F₆, SF₆, etc. or more likely combinations of the above or with additional gases, such as CF₄/H₂, SF₆/Cl₂, or gases using more than one etching species such as CF₂Cl₂, all possibly with one or more optional inert diluents). Of course, if different materials are used for the reinforcing layer and the hinge layer, then a different etchant can be employed for etching each layer. Alternatively, the reflective layer can be deposited before the first (reinforcing) and/or second (hinge) layer. Whether deposited prior to the hinge material or prior to both the hinge material and the reinforcing material, it is preferable that the metal be patterned (e.g. removed in the hinge area) prior to depositing and patterning the hinge material.

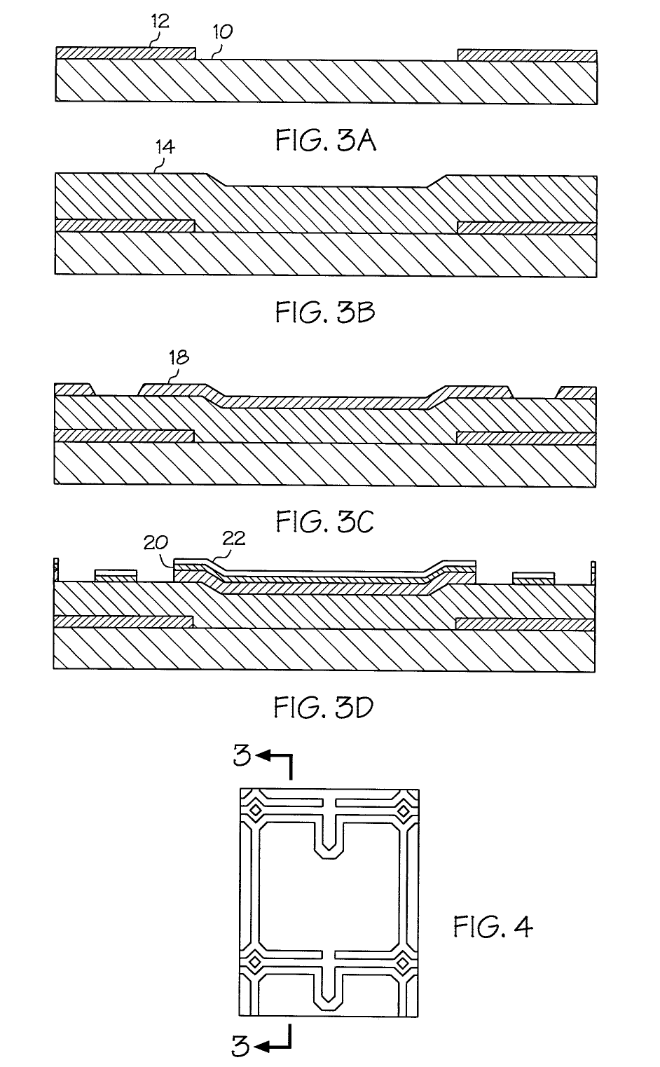

FIGS. 3A to 3D illustrate the same process taken along a different cross section (cross section 3-3 in FIG. 4) and show the optional block layer 12 deposited on the light transmissive substrate 10, followed by the sacrificial layer 14, layers 18, 20 and the metal layer 22. The cross sections in FIGS. 1A to 1D and 3A to 3D are taken along substantially square mirrors in FIGS. 2 and 4 respectively. However, the mirrors need not be square but can have other shapes that may decrease diffraction and increase the contrast ratio. Such mirrors are in U.S. provisional patent application No. 60/229,246 to IIkov et al., the subject matter of which is incorporated herein by reference.

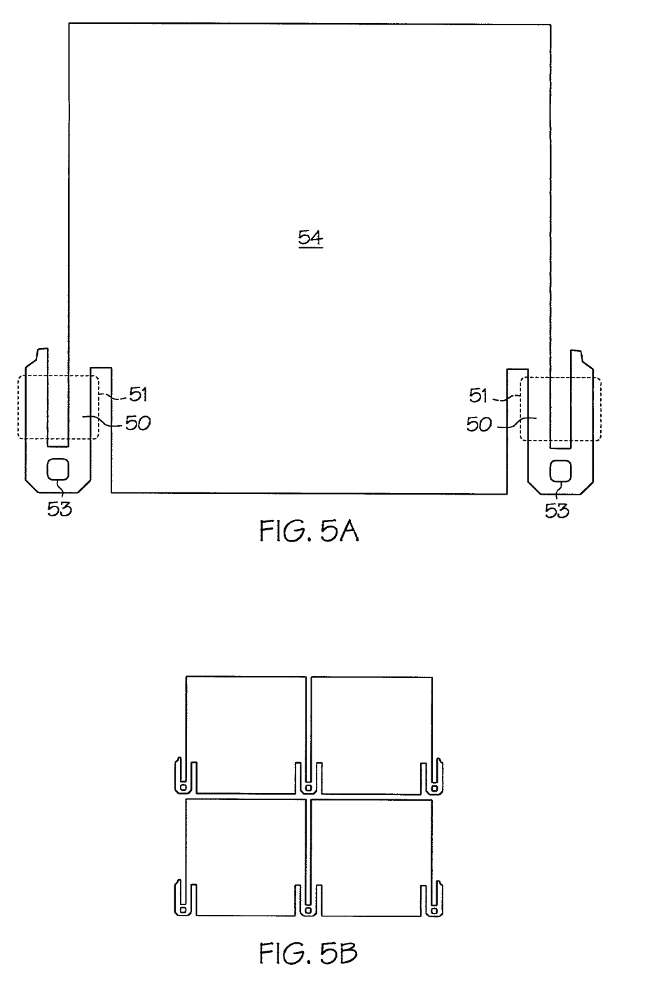

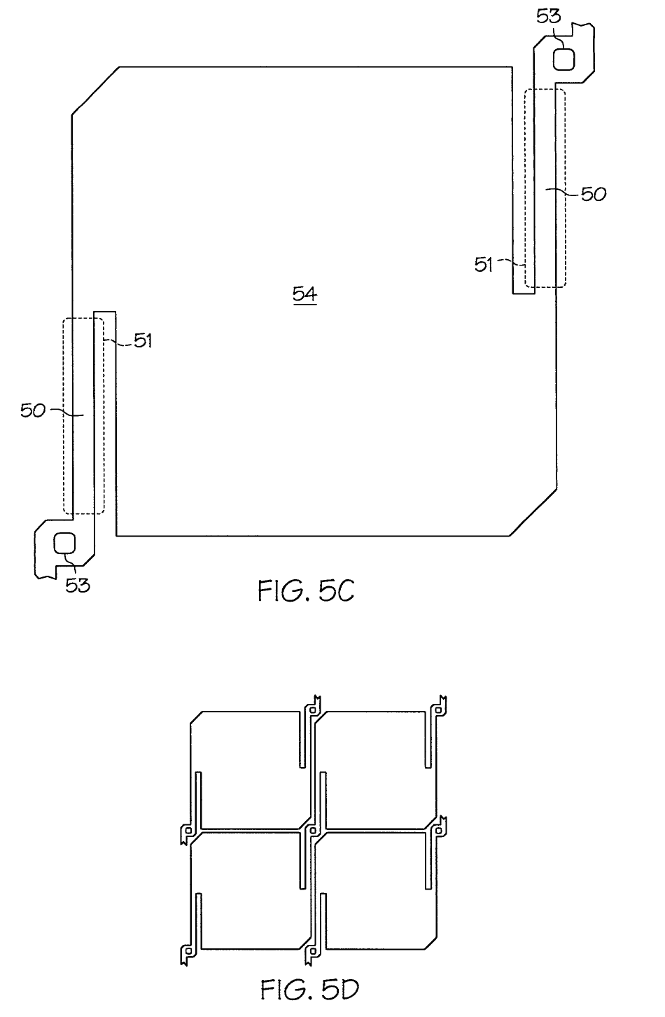

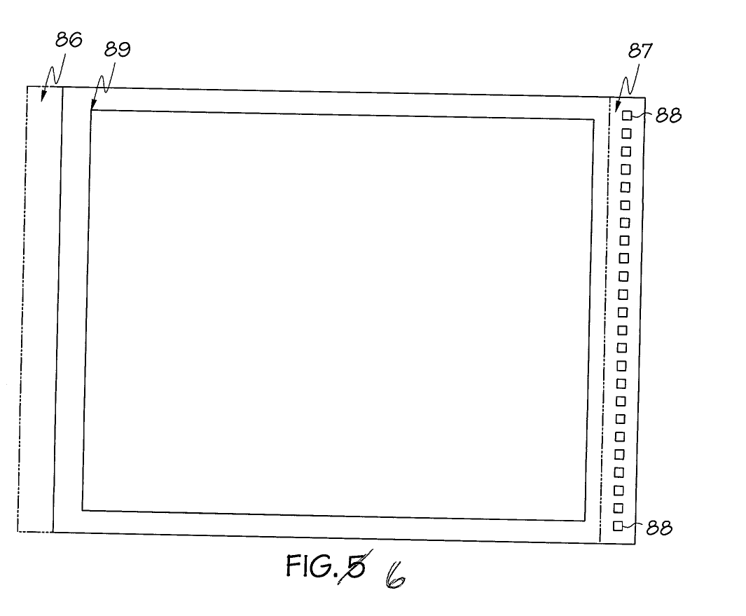

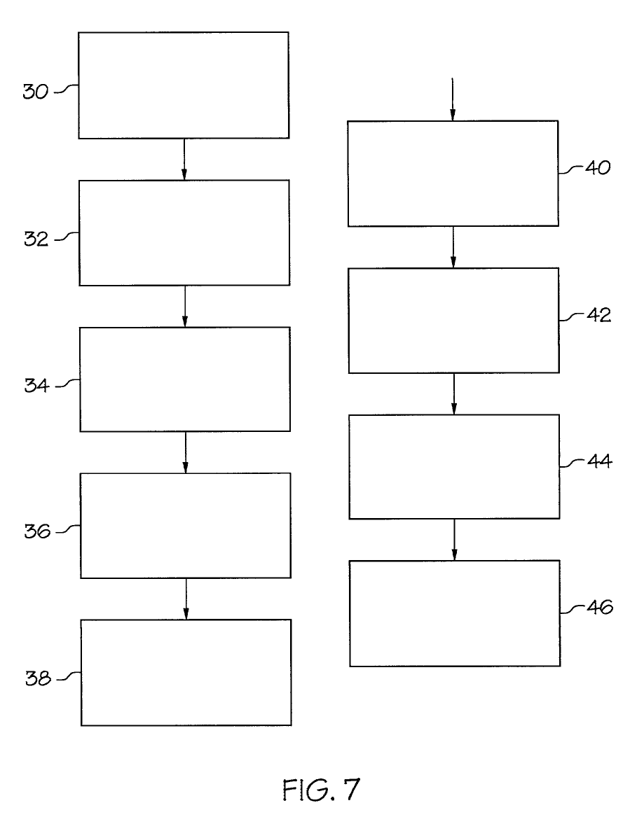

Also, the mirror hinges can be torsion hinges as illustrated in provisional application No. 60/229,246 and as illustrated in FIGS. 5A to 5D. As can be seen in FIG. 5A, flexure hinges 50 are disposed on opposite sides of mirror 51. Areas 51 correspond to areas of the reinforcing layer that are removed prior to forming hinges 50. Posts 53 connect the hinged mirror 54 to the substrate. FIG. 5C similarly discloses hinges 50, areas 51 corresponding to areas of the reinforcing layer removed, posts 53 and mirror 54. FIGS. 5B and 5D illustrate what four mirrors within a larger array look like if the embodiments of FIGS. 5A and 5C were to be utilized.

It should also be noted that materials mentioned above are examples only, as many other materials for the reinforcing and hinge layers (and sacrificial layer) could be used. For example, the Sandia SUMMiT process (using polysilicon for structural layers) or the Cronos MUMPS process (also polysilicon for structural layers) could be used in the present invention. Also, a MOSIS process (AMI ABN—1.5 um CMOS process) could be adapted for the present invention, as could a MUSiC process (using polycrystalline SiC for the structural layers) as disclosed, for example, in Mehregany et al., Thin Solid Films, v. 355-356, pp. 518-524,1999. Also, the sacrificial layer and etchant disclosed herein are exemplary only. For example, a silicon dioxide sacrificial layer could be used and removed with HF (or HF/HCl), or a silicon sacrificial could be removed with CIF3 or BrF3. Also a PSG sacrificial layer could be removed with buffered HF, or an organic sacrificial such as polyimide could be removed in a dry plasma oxygen release step. Of course the etchant and sacrificial material should be selected depending upon the structural material to be used.

Backplane

The second or “lower” substrate (the backplane) die contains a large array of electrodes on a top metal layer of the die. Each electrode electrostatically controls one pixel (one micromirror on the upper optically transmissive substrate) of the microdisplay. The voltage on each electrode on the surface of the backplane determines whether its corresponding microdisplay pixel is optically ‘on’ or ‘off,’ forming a visible image on the microdisplay. Details of the backplane and methods for producing a pulse-width-modulated grayscale or color image are disclosed in U.S. patent application Ser. No. 09/564,069 to Richards, the subject matter of which is incorporated herein by reference.

The display pixels themselves, in a preferred embodiment, are binary, always either fully ‘on’ or fully ‘off,’ and so the backplane design is purely digital. Though the micromirrors could be operated in analog mode, no analog capability is necessary. For ease of system design, the backplane's I/O and control logic preferably run at a voltage compatible with standard logic levels, e.g. 5V or 3.3V. To maximize the voltage available to drive the pixels, the backplane's array circuitry may run from a separate supply, preferably at a higher voltage.

One embodiment of the backplane can be fabricated in a foundry 5V logic process. The mirror electrodes can run at 0-5V or as high above 5V as reliability allows. The backplane could also be fabricated in a higher-voltage process such as a foundry Flash memory process using that process's high-voltage devices. The backplane could also be constructed in a high-voltage process with larger-geometry transistors capable of operating at 12V or more. A higher voltage backplane can produce an electrode voltage swing significantly higher than the 5-7V that the lower voltage backplane provides, and thus actuate the pixels more robustly.

In digital mode, it is possible to set each electrode to either state (on/off), and have that state persist until the state of the electrode is written again. A RAM-like structure, with one bit per pixel is one architecture that accomplishes this. One example is an SRAM-based pixel cell. Alternate well-known storage elements such as latches or DRAM (pass transistor plus capacitor) are also possible. If a dynamic storage element (e.g. a DRAM-like cell) is used, it is desirable that it be shielded from incident light that might otherwise cause leakage.

The perception of a grayscale or full-color image will be produced by modulating pixels rapidly on and off, for example according to the method in the above-mentioned U.S. patent application Ser. No. 09/564,069 to Richards. In order to support this, it is preferable that the backplane allows the array to be written in random-access fashion, though finer granularity than a row-at-a-time is generally not necessary.

It is desirable to minimize power consumption, primarily for thermal reasons. Decreasing electrical power dissipation will increase the optical/thermal power budget, allowing the microdisplay to tolerate the heat of more powerful lamps. Also, depending upon the way the microdisplay is assembled (wafer-to-wafer join+offset saw), it may be preferable for all I/O pads to be on one side of the die. To minimize the cost of the finished device it is desirable to minimize pin count. For example, multiplexing row address or other infrequently-used control signals onto the data bus can eliminate separate pins for these functions with a negligible throughput penalty (a few percent, e.g. one clock cycle for address information per row of data is acceptable). A data bus, a clock, and a small number of control signals (5 or less) are all that is necessary.

In use, the die can be illuminated with a 200 W or more arc lamp. The thermal and photo-carrier effects of this may result in special layout efforts to make the metal layers as ‘opaque’ as possible over the active circuitry to reflect incident optical energy and minimize photocarrier and thermal effects. An on-chip PN diode could be included for measuring the temperature of the die.

In one embodiment the resolution is XGA, 1024×768 pixels, though other resolutions are possible. A pixel pitch of from 5 to 24 um is preferred (e.g. 14 um). The size of the electrode array itself is determined by the pixel pitch and resolution. A 14 um XGA device's pixel array will therefore be 14.336×10.752 mm.

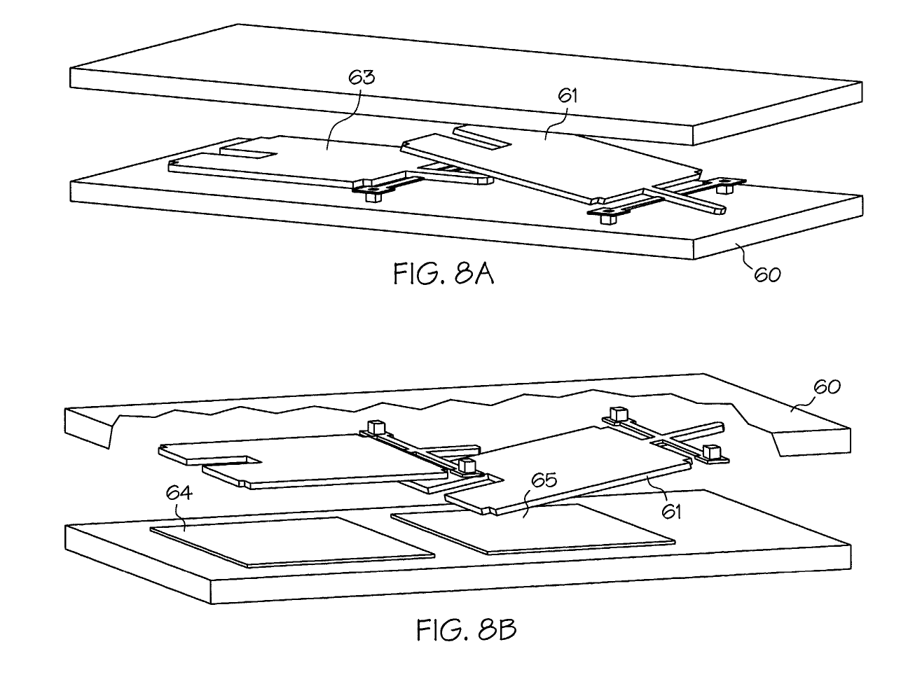

As can be seen in FIG. 6, the I/O pads (88) can be placed along the right edge of the die, as the die is viewed with pixel (0,0) (89 in FIG. 6) at the top left corner. Putting the pads on the ‘short’ (left/right) edge (87) of the die is preferable due to the slightly reduced die size. The choice of whether the I/O should go on the left vs. right edge of the die is of little importance since the display controller ASIC may support mirroring the displayed image in the horizontal axis, the vertical axis, or both. If it is desired to orient the display with the I/O on the left edge, the image may simply be rotated 180 degrees by the external display controller. The electrode voltage during operation is, in the low state 0V and in the high state preferably from 5 to 7 V (or 12V or higher in the higher voltage design). Of course other voltages are possible, though lower actuation voltages are preferred. In one embodiment the electrodes are metal squares, though other geometries are possible. Standard CMOS passivation stackup over the electrodes can be provided.

Assembly

After the upper and lower substrates (wafers) are finished being processed (e.g. circuitry/electrodes on lower wafer, micromirrors on upper wafer), the upper and lower wafers are joined together. The method for the assembly of the wafers and separation of the wafer assembly into individual dies is set forth in FIG. 7 and is similar in many respects to the method for assembly of a liquid crystal device as disclosed in U.S. Pat. No. 5,963,289 to Stefanov et al, “Asymmetrical Scribe and Separation Method of Manufacturing Liquid Crystal Devices on Silicon Wafers”, which is hereby incorporated by reference. Whether the upper and lower wafer are made of the same or different materials (silicon, glass, dielectric, multilayer wafer, etc.), they can first be inspected (step 30 in FIG. 7) for visual defects, scratches, particles, etc. After inspection, the wafers can be processed through industry standard cleaning processes (step 32). These include scrubbing, brushing or ultrasonic cleaning in a solvent, surfactant solution, and/or de-ionized (Dl) water.

If the mirrors on the upper wafer have not been released, they should be released at this point (step 34). Releasing immediately prior to the application of epoxy or bonding is preferable (except for an optional stiction treatment between release and bonding). For silicon sacrificial layers, the release is in an atmosphere of xenon difluoride and an optional diluent (e.g. nitrogen and/or helium). Of course, other etchants could be used, including interhalogens such as bromine trifluoride and bromine trichloride. The release is preferably a spontaneous chemical etch which does not require plasma or other external energy to etch the silicon sacrificial layer(s). After etching, the remainder of the device is treated for stiction (step 36) by applying an anti-stiction layer (e.g. a self assembled monolayer). The layer is preferably formed by placing the device in a liquid or gas silane, preferably a halosilane, and most preferably a chlorosilane. Of course, many different silanes are known in the art for their ability to provide anti-stiction for MEMS structures.

In order to bond the two wafers together, spacers are mixed into sealant material (step 38). Spacers in the form of spheres or rods are typically dispensed and dispersed between the wafers to provide cell gap control and uniformity and space for mirror deflection. Spacers can be dispensed in the gasket area of the display and therefore mixed into the gasket seal material prior to seal dispensing. This is achieved through normal agitated mixing processes. The final target for the gap between the upper and lower wafers is preferably from 1 to 10 um. This of course depends upon the type of MEMS structure being encapsulated and whether it was surface or bulk micromachined. The spheres or rods can be made of glass or plastic, preferably an elastically deforming material. Alternatively, spacer pillars can be fabricated on at least one of the substrates. In one embodiment, pillars/spacers are provided only at the edge of the array. In another embodiment, pillars/spacers can be fabricated in the array itself. Other bonding agents with or without spacers could be used, including anodic bonding or metal compression bonding with a patterned eutectic.

A gasket seal material can then be dispensed (step 40) on the bottom substrate in a desired pattern, usually in one of two industry standard methods including automated controlled liquid dispensing through a syringe and printing (screen, offset, or roller). When using a syringe, it is moved along X-Y coordinates relative to the parts. The syringe tip is constrained to be just above the part with the gasket material forced through the needle by positive pressure. Positive pressure is provided either by a mechanical plunger forced by a gear driven configuration and/or by an air piston and/or pressed through the use of an auger. This dispensing method provides the highest resolution and process control but provides less throughput.

Then, the two wafers are aligned (step 42). Alignment of the opposing electrodes or active viewing areas requires registration of substrate fiducials on opposite substrates. This task is usually accomplished with the aid of video cameras with lens magnification. The machines range in complexity from manual to fully automated with pattern recognition capability. Whatever the level of sophistication, they accomplish the following process: 1. Dispense a very small amount of a UV curable adhesive at locations near the perimeter and off of all functional devices in the array; 2. Align the fiducials of the opposing substrates within the equipment capability; and 3. Press substrates and UV tack for fixing the wafer to wafer alignment through the remaining bonding process (e.g., curing of the internal epoxy).

The final cell gap can be set by pressing (step 44) the previously tacked laminates in a UV or thermal press. In a UV press, a common procedure would have the substrates loaded into a press where at least one or both of the press platens are quartz, in order to allow UV radiation from a UV lamp to pass unabated to the gasket seal epoxy. Exposure time and flux rates are process parameters determined by the equipment and adhesive materials. Thermally cured epoxies require that the top and bottom platens of a thermal press be heated. The force that can be generated between the press platens is typically many tons. With thermally cured epoxies, after the initial press the arrays are typically transferred to a stacked press fixture where they can continue to be pressed and post-cured for 4-8 hours. Once the wafers have been bonded together to form a wafer assembly, the assembly can be separated into individual dies (step 46). Silicon substrate and glass scribes are placed on the respective substrates in an offset relationship at least along one direction. The units are then separated, resulting in each unit having a bond pad ledge on one side and a glass electrical contact ledge on an opposite side. The parts may be separated from the array by any of the following methods. The order in which the array (glass first) substrate is scribed is important when conventional solid state cameras are used for viewing and alignment in a scribe machine. This constraint exists unless special infrared viewing cameras are installed which make the silicon transparent and therefore permits viewing of front surface metal fiducials. The scribe tool is aligned with the scribe fiducials and processed. The resultant scribe lines in the glass arc used as reference marks to align the silicon substrate scribe lanes. These scribe lanes may be coincident with the glass substrate scribes or uniformly offset. The parts are then separated from the array by venting the scribes on both substrates. Automatic breaking is done by commercially available guillotine or fulcrum breaking machines. The parts can also be separated by hand.

Separation may also by done by glass scribing and partial sawing of the silicon substrate. Sawing requires an additional step at gasket dispense. Sawing is done in the presence of a high-pressure jet of water. Moisture must not be allowed in the area of the fill port or contamination of the polyimide alignment layer will occur. Therefore, at gasket dispense, an additional gasket bead must be dispensed around the perimeter of the wafer. The end of each scribe/saw lane must be initially left open, to let air vent during the align and press processes. After the array has been pressed and the gasket material cured, the vents are then closed using either the gasket or end-seal material. The glass is then aligned and scribed as described above. Sawing of the wafer is done from the backside of the silicon where the saw streets are aligned relative to the glass scribe lanes described above. The wafer is then sawed to a depth of 50%-90% of its thickness. The parts are then separated as described above.

Alternatively, both the glass and silicon substrates may be partially sawed prior to part separation. With the same gasket seal configuration, vent and seal processes as described above, saw lanes are aligned to fiducials on the glass substrates. The glass is sawed to a depth between 50% and 95% of its thickness. The silicon substrate is sawed and the parts separated as described above.

There are many alternatives to the method of the present invention. In order to bond the two wafers, epoxy can be applied to the one or both of the upper and lower wafers. In a preferred embodiment, epoxy is applied to both the circumference of the wafer and completely or substantially surrounding each die/array on the wafer. Spacers can be mixed in the epoxy so as to cause a predetermined amount of separation between the wafers after bonding. Such spacers hold together the upper and lower wafers in spaced-apart relation to each other. The spacers act to hold the upper and lower wafers together and at the same time create a space in which the movable mirror elements can move. Alternatively, the spacer layer could comprise walls or protrusions that are micro-fabricated. Or, one or more wafers could be bonded between the upper and lower wafers and have portions removed (e.g. by etching) in areas corresponding to each mirror array (thereby providing space for deflection of the movable elements in the array). The portions removed in such intermediate wafers could be removed prior to alignment and bonding between the upper and lower wafers, or, the wafer(s) could be etched once bonded to either the upper or lower wafer. If the spacers are micro-fabricated spacers, they can be formed on the lower wafer, followed by the dispensing of an epoxy, polymer, or other adhesive (e.g. a multi-part epoxy, or a heat or UV-cured adhesive) adjacent to the micro-fabricated spacers. The adhesive and spacers need not be co-located, but could be deposited in different areas on the lower substrate wafer. Alternative to glue, a compression bond material could be used that would allow for adhesion of the upper and lower wafers. Spacers micro-fabricated on the lower wafer (or the upper wafer) and could be made of polyimide, SU-8 photo-resist.

Instead of microfabrication, the spacers could be balls or rods of a predetermined size that are within the adhesive when the adhesive is placed on the lower wafer. Spacers provided within the adhesive can be made of glass or plastic, or even metal so long as the spacers do not interfere with the electrostatic actuation of the movable element in the upper wafer. Regardless of the type of spacer and method for making and adhering the spacers to the wafers, the spacers are preferably from 1 to 250 microns, the size in large part depending upon the size of the movable mirror elements and the desired angle of deflection. Whether the mirror arrays are for a projection display device or for optical switching, the spacer size in the direction orthogonal to the plane of the upper and lower wafers is more preferably from 1 to 100 microns, with some applications benefiting from a size in the range of from 1 to 20 microns, or even less than 10 microns.

In the method of the invention, the first wafer is preferably a light transmissive substrate such as glass, borosilicate, tempered glass, quartz or sapphire, or any other suitable light transmissive material. The second wafer can be a dielectric or semiconductor wafer, e.g. GaAs or silicon. As noted above, the first and second wafers are bonded together with an adhesive (thought metal, anodic or other standard wafer bonding methods are also possible, depending upon the MEMS structure and the type of micromachining).

Preferably the time from releasing to bonding is less than 12 hours, and preferably less than 6 hours. One example of the present invention after the mirrors are released and the wafers are bonded and singulated, is shown in FIGS. 8A and 8B (these figures being upside down with respect to each other). As can be seen in FIG. 8A, both a deflected mirror 61 and an undeflected mirror 63 are held on an optically transmissive substrate 60. Addressing electrodes 64 and 65 are provided for electrostatically attracting the adjacent mirrors (in FIG. 8B a voltage is applied to FIG. 65 to cause mirror 61 to deflect).

It should be noted that the invention is applicable to forming micromirrors such as for a projection display or optical switch, or any other MEMS device which requires one area to be stiffer relative to another area (e.g. a diaphragm or shunt RF MEMS switch). If for an optical switch, multiple hinges can be provided in areas where the reinforcing material has been removed, so as to allow for multi-axis movement of the mirror. Such multi-axis movement, mirrors for achieving such movement, and methods for making such mirrors (including providing a reinforcing layer and removing a portion in the hinge area) are disclosed in U.S. Pat. No. 09/617,149 to Huibers et al., the subject matter of which is incorporated herein by reference.

The reinforcing layer of the present invention need not be a single layer, but could be multiple layers provided for increasing the stiffness of the movable element. However many layers, it is desirable to remove such layers in the area in which the hinge will layer be formed. Likewise, the hinge layer could be provided as multiple layers, with at least the first layer being preferably deposited directly upon the sacrificial layer. In this way, when ultimately patterning the movable element and hinge(s), any overetching will preferably be within the sacrificial layer rather than into a structural layer of the device.

The invention has been described in terms of specific embodiments. Nevertheless, persons familiar with the field will appreciate that many variations exist in light of the embodiments described herein.

We claim:

1. A method for forming a micromechanical device, comprising:
providing a substrate;
providing a sacrificial layer on the substrate;
providing a stiffening layer directly or indirectly on the sacrificial layer;
providing a hinge layer that is disposed in at least one area in which the stiffening layer is not present; and
removing the sacrificial layer.

2. The method of claim 1, wherein the substrate is a dielectric or semiconductor wafer.

3. The method of claim 2, wherein the substrate is a silicon or glass wafer.

4. The method of claim 1, wherein the sacrificial layer comprises silicon dioxide, amorphous silicon, polysilicon or an organic material.

5. The method of claim 4, wherein the sacrificial layer is spun on or deposited by chemical vapor deposition.

6. The method of claim 1, wherein the stiffening layer is provided by chemical vapor deposition.

7. The method of claim 6, wherein the chemical vapor deposition is PECVD or LPCVD.

8. The method of claim 1, wherein the stiffening layer is deposited and patterned prior to providing the one or more flexible layers.

9. The method of claim 8, wherein the stiffening layer is patterned by lithography and etching.

10. The method of claim 8, wherein the stiffening layer is provided with a thickness of from 100 to 3200 Å.

11. The method of claim 10, wherein the stiffening layer is provided with a thickness of from 500 Å to 1900 Å.

12. The method of claim 1, wherein the sacrificial layer is provided with a thickness of from 500 Å to 50,000 Å.

13. The method of claim 12, wherein the sacrificial layer is provided with a thickness of from about 1000 to 25,000 Å.

14. The method of claim 1, wherein the stiffening layer is of a material different than the sacrificial layer.

15. The method of claim 14, wherein the stiffening layer comprises silicon, silicon nitride, silicon dioxide, or silicon carbide.

16. The method of claim 14, further comprising depositing a layer comprising metal after providing the hinge layer.

17. The method of claim 16, wherein the layer comprising metal is a reflective and conductive layer.

18. The method of claim 17, wherein the reflective and conductive layer is a layer comprising a metal or transition metal.

19. The method of claim 18, wherein the metal is aluminum.

20. The method of claim 19, wherein the aluminum is deposited by sputtering.

21. The method of claim 16, wherein the metal layer, hinge layer and reinforcing layer are patterned at the same time with the same etchant.

22. The method of claim 1, wherein part of the reinforcing layer corresponding to the intended hinge location is removed prior to depositing the hinge layer.

23. The method of claim 22, wherein the hinge layer and reinforcing layer are patterned together.

24. The method of claim 1, wherein the reinforcing layer has a greater thickness than the hinge layer.

25. The method of claim 1, wherein the hinge layer and reinforcing layer are of different materials.

26. The method of claim 1, wherein the hinge layer is patterned to define multiple hinges.

27. The method of claim 1, wherein the hinge layer is patterned to define an elongated torsion hinge.

28. The method of claim 26, wherein the hinge layer is patterned to define multiple flexure hinges extending along opposite sides of a movable element defined by patterning both the hinge and reinforcing layers.

29. The method of claim 1, further comprising patterning the hinge layer and reinforcing layer to define a movable plate, and patterning the hinge layer to define a hinge connected to the movable plate, prior to removing the sacrificial layer.

30. The method of claim 29, further comprising patterning the hinge layer and reinforcing layer to define posts that connect the hinged plate to the substrate.

31. The method of claim 30, wherein a portion of the reinforcing layer corresponding to the intended location of the hinge is removed prior to depositing the hinge material, and wherein a portion of the sacrificial layer is removed corresponding to the intended location of the posts prior to depositing the reinforcing layer.

32. The method of claim 29, further comprising providing a second substrate and forming circuitry and an electrode thereon.

33. The method of claim 32, further comprising bonding the second substrate to the first substrate so that the electrode and movable plate are disposed proximate to each other.

34. The method of claim 33, wherein multiple movable plates are formed on the substrate and multiple electrodes are formed on the second substrate.

35. The method of claim 34, wherein the bonded substrates are singulated after bonding into multiple bonded substrate portions that comprise at least one movable element therebetween.

36. The method of claim 33, wherein the electrode is positioned after bonding to selectively deflect the movable plate when a bias voltage is applied between the electrode and the movable element.

37. The method of claim 29, wherein the patterned movable plate is held on a bottom surface of the substrate, and wherein the movable plate has first and second portions such that during deflection of the plate, the second portion of the movable plate moves towards the bottom surface of the substrate as the first portion moves away from the bottom surface.

38. The method of claim 33, wherein substrate is a glass wafer and the second substrate is a silicon wafer.

39. The method of claim 33, wherein multiple dies are formed on the wafers, each die having multiple movable plates for steering light beams for an optical switch or projection display.

40. The method of claim 39, wherein each die has from about 6,000 to about 6 million movable plates, each plate corresponding to a pixel in a displayed image.

41. The method of claim 38, wherein the wafers are bonded together with an epoxy.

42. The method of claim 41, wherein the epoxy comprises balls or spacers of predetermined diameter or diameter range.

43. The method of claim 38, further comprising providing microfabricated spacers on one or both of the wafers.

44. The method of claim 1, further comprising providing a stiction agent after removing the sacrificial layer.

45. The method of claim 1, wherein the hinge layer is deposited directly on the sacrificial layer.

46. A method for forming a micromirror, comprising:
providing a substrate;
providing a sacrificial layer on the substrate;
providing one or more layers for a movable element and hinge;
providing a metal layer after providing the one or more layers;
patterning the one or more layers and metal layer to define a conductive and reflective hinged movable element on the substrate; and
removing the sacrificial layer.

47. The method of claim 46, wherein the one or more layers are a plurality of layers that include a reinforcing layer and a hinge layer.

48. The method of claim 47, wherein the reinforcing layer is provided before the hinge layer.

49. The method of claim 48, wherein a portion of the reinforcing layer is removed in an area intended for the hinge, prior to depositing the hinge layer.

50. The method of claim 49, wherein the a portion of the hinge layer is provided directly on the sacrificial layer.

51. The method of claim 46, wherein the one or more layers and the metal layer are patterned together.

52. The method of claim 47, wherein a portion of the sacrificial layer is removed prior to providing the reinforcing layer so that the reinforcing layer connects to the substrate at the removed portion.

53. The method of claim 52, wherein the removed portion is a plurality of apertures and both the reinforcing layer and the hinge layer are provided in the portion corresponding to the plurality of apertures.

54. A spatial light modulator, comprising:
an array of pixels, each pixel comprising at least one deflectable element with one or more flexible portions that undergo deformation upon the application of an actuation force;
each deflectable element comprising a first structural layer and a second structural layer formed after and on top of the first structural layer;
wherein the one or more flexible portions are formed in the second layer and not the first layer.

55. The spatial light modulator of claim 54, wherein the pixels are held on a dielectric or semiconductor substrate.

56. The spatial light modulator of claim 55, wherein the substrate is a portion of a silicon or glass wafer.

57. The spatial light modulator of claim 8, wherein the first structural layer has a thickness of from 100 to 3200 Å.

58. The spatial light modulator of claim 57, wherein the first structural layer is provided with a thickness of from 500 to 1900 Å.

59. The spatial light modulator of claim 58, wherein the first structural layer comprises silicon, silicon nitride, silicon dioxide, or silicon carbide.

60. The spatial light modulator of claim 54, further comprising a metal layer on the second structural layer.

61. The spatial light modulator of claim 60, wherein the metal layer is a reflective and conductive layer.

62. The spatial light modulator of claim 61, wherein the reflective and conductive layer is a layer comprising a metal or transition metal.

63. The spatial light modulator of claim 62, wherein the metal is aluminum.

64. The spatial light modulator of claim 1, wherein the first structural layer has a greater thickness than the second structural layer.

65. The spatial light modulator of claim 54, wherein the first structural layer and the second structural layer are of different materials.

66. The spatial light modulator of claim 54, wherein the one or more flexible portions comprise a plurality of hinges.

67. The spatial light modulator of claim 54, wherein the one or more flexible portions are an elongated torsion hinge.

68. The spatial light modulator of claim 66, wherein the plurality of hinges are multiple flexure hinges extending along opposite sides of the deflectable element.

69. The spatial light modulator of claim 54, further comprising posts that connect the deflectable element to a light transmissive substrate.

70. The spatial light modulator of claim 55, further comprising a second substrate with circuitry and an electrode thereon.

71. The spatial light modulator of claim 70, wherein the second substrate is bonded to the first substrate so that the electrode and deflectable element are disposed proximate to each other.

72. The spatial light modulator of claim 70, wherein multiple movable plates are formed on the substrate and multiple electrodes are formed on the second substrate.

73. The spatial light modulator of claim 55, wherein the deflectable element has first and second portions such that during deflection of the plate, the second portion of the deflectable element moves towards the substrate as the first portion moves away from the substrate.

74. The spatial light modulator of claim 71, wherein the substrate is the whole or part of a glass wafer and the second substrate is the whole or part of a silicon wafer.

75. The spatial light modulator of claim 55, wherein the substrate holds from about 6,000 to about 6 million deflectable elements.

76. A method for forming a spatial light modulator, comprising:
providing a sacrificial layer on a substrate;
providing one or more layers for a movable element and hinge at a temperature greater than 400 degrees Celsius; and
providing a metal layer after providing the one or more layers;

77. A method for forming a spatial light modulator in a CMOS foundry, comprising:
providing a CMOS foundry to make the spatial light modulator;
providing a substrate wafer into the CMOS assembly line;
providing a sacrificial layer comprising silicon;
providing one or more high temperature insulating layers; providing a metal layer after the insulating layer or layers; and removing the sacrificial layer; wherein the CMOS foundry rules that high temperature insulating
layers are provided prior to providing metal, are followed.

78. A projection system, comprising:
a light source;
a color wheel or prism for providing sequential color;
a spatial light modulator, comprising
an array of pixels, each pixel comprising at least one deflectable element with one or more flexible portions that undergo deformation upon the application of an actuation force;
each deflectable element comprising a first structural layer and a second structural layer formed after and on top of the first structural layer;
wherein the one or more flexible portions are formed in the second layer and not the first layer;
and projection optics for projecting light from the light source that passes via the color wheel or prism and is reflected from the spatial light modulator.
